(19) United States
(12) Patent Application Publication
(10) Pub. No.: US 2026/0249524 A1
(43) Pub. Date: Aug. 27, 2026

(54) SURFACE MEMBER, METHOD OF MANUFACTURING LAMINATED MOLDED PRODUCT, AND PRESS APPARATUS

(71) Applicant: THE JAPAN STEEL WORKS, LTD., Shinagawa-ku, Tokyo (JP)

(72) Inventor: Takayuki YAMAMOTO, Shinagawa-ku, Tokyo (JP)

(21) Appl. No.: 19/121,950

(22) PCT Filed: Nov. 4, 2022
(86) PCT No.: PCT/JP2022/041110

§ 371 Date: Apr. 17, 2025

(51) Int. Cl. B29C 43/36; B29C 43/20; B29C 43/56

(52) U.S. Cl. CPC B29C 43/36; B29C 43/203; B29C 43/56; B29C 2043/366; B29C 2043/563; B29K 2905/12; B29K 2909/04

(57) ABSTRACT

Provided are a lamination molding system, which is improved over a conventional system in at least one of uniformity of surface pressure distribution during pressurization of a press apparatus, smoothness of a laminated molded product, and releasability upon the completion of laminate molding, and a lamination molding method using the lamination molding system. In a lamination molding system including a vacuum laminating apparatus and a press apparatus disposed in a subsequent stage of the vacuum laminating apparatus, the press apparatus includes pressurizing blocks attached to at least one of an upper platen and a lower platen, buffer members attached to surfaces of the pressurizing blocks, and metal plates attached to surfaces of the buffer members, and the surfaces of the metal plates are formed with coating layers formed of at least one of titanium or a titanium alloy, nickel or a nickel alloy, metal nitride, and DLC.

### TECHNICAL FIELD

The present invention relates to a lamination molding system including a vacuum laminating apparatus, a press apparatus disposed in a subsequent stage of the vacuum laminating apparatus, and a conveyance apparatus that conveys an intermediate laminate laminated and molded by the vacuum laminating apparatus to the press apparatus, and a lamination molding method using the lamination molding system.

### BACKGROUND ART

As in disclosed in Patent Literature 1, a lamination molding system including a vacuum laminating apparatus, a press apparatus disposed in a subsequent stage of the vacuum laminating apparatus, and a conveyance apparatus that conveys an intermediate laminate laminated and molded by the vacuum laminating apparatus to the press apparatus is known. In Patent Literature 1, a flattening press machine, which is a press apparatus, is provided in a subsequent stage of the vacuum laminating apparatus. The flattening press includes a buffer member made of rubber or the like having a thickness of, for example, about 1.5 mm attached to a surface of a polishing plate serving as a pressurizing block, and an elastically deformable mirror plate made of stainless steel or the like having a thickness of about 2 mm attached to a surface of the buffer member. It is described that during molding, the mirror plate constituting the molding surface initially elastically deforms according to unevenness of the product's surface, and then gradually returns to its original flat surface due to the elastic deformation of the buffer member and the elastic deformation of the mirror plate.

### CITATION LIST

### Patent Literature

Patent Literature 1: Japanese Unexamined Patent Application Publication No. 2002-120100

### SUMMARY OF INVENTION

However, according to the press apparatus of the conventional lamination molding systems, there were cases where results were not fully satisfactory in at least one of uniformity of surface pressure distribution during pressurization, smoothness of the laminated molded product which was laminated and molded, and releasability upon completion of laminate molding. Therefore, the present invention aims to provide a lamination molding system and a lamination molding method using the lamination molding system, the lamination molding system being improved over a conventional system in at least one of uniformity of surface pressure distribution during pressurization of the press apparatus, smoothness of the laminated molded product, and releasability upon the completion of the laminate molding.

Other problems and novel features will become apparent from the description of the present specification and the accompanying drawings.

A lamination molding system described in claim 1 of the present invention includes a vacuum laminating apparatus, a press apparatus disposed in a subsequent stage of the vacuum laminating apparatus, and a conveyance apparatus that conveys an intermediate laminate laminated and molded by the vacuum laminating apparatus to the press apparatus, the press apparatus includes pressurizing blocks attached to at least one of an upper platen and a lower platen, buffer members attached to surfaces of the pressurizing blocks, and metal plates attached to surfaces of the buffer members, and the surfaces of the metal plates are formed with coating layers formed of at least one of titanium or a titanium alloy, nickel or a nickel alloy, metal nitride, and DLC.

In the lamination molding system of the present invention including the vacuum laminating apparatus, the press apparatus disposed in the subsequent stage of the vacuum laminating apparatus, and the conveyance apparatus that conveys the intermediate laminate laminated and molded by the vacuum laminating apparatus to the press apparatus, the press apparatus includes the pressurizing blocks attached to at least one of the upper platen and the lower platen, the buffer members attached to the surfaces of the pressurizing blocks, and the metal plates attached to the surfaces of the buffer members, and the surfaces of the metal plates are formed with the coating layers formed of at least one of titanium or a titanium alloy, nickel or a nickel alloy, metal nitride, and DLC, whereby it is possible to obtain a good result in at least one of uniformity of surface pressure distribution during pressurization, smoothness of a laminated molded product, and releasability upon the completion of laminate molding.

### BRIEF DESCRIPTION OF DRAWINGS

FIG. 1 is a schematic explanatory diagram of a lamination molding system according to a first embodiment;

FIG. 2 is an enlarged view of a main portion of the lamination molding system according to the first embodiment;

FIG. 3 is a schematic explanatory diagram of a lamination molding system according to a second embodiment;

FIG. 4 is a schematic explanatory diagram of a lamination molding system according to a third embodiment; and

FIG. 5 is a schematic explanatory diagram when pressure molding is performed using a press apparatus of a conventional lamination molding system.

### DESCRIPTION OF EMBODIMENTS

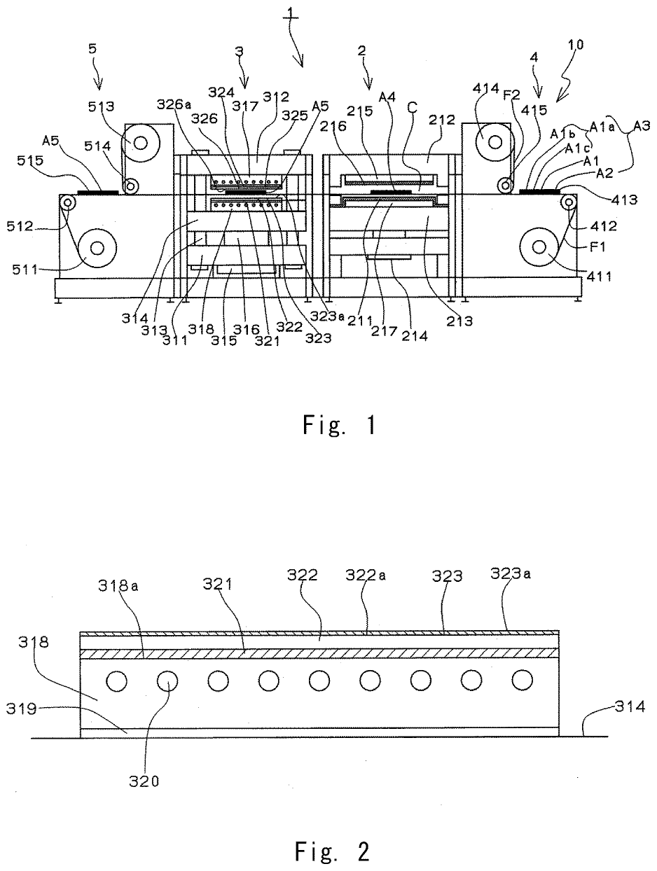

A lamination molding system 1 according to a first embodiment of the present invention will be described with reference to FIG. 1 in which a vacuum laminating apparatus 2 and a press apparatus 3 are shown in a cross-sectional view. In the lamination molding system 1, the press apparatus 3 is disposed in a subsequent stage of the vacuum laminating apparatus 2, and an intermediate laminate A4 formed by a substrate A1 and a laminating film A2 is pressure-molded by the press apparatus 3, the substrate A1 having an uneven portion and being a member to be laminated, the substrate A1 and the laminating film A2 being conveyed from the vacuum laminating apparatus 2 by carrier films F1 and F2 sent by a conveyance apparatus.

A carrier film unwinding apparatus 4 of the conveyance apparatus 10 serving as both a transfer apparatus and a tension apparatus for the substrate A1 and the laminating film A2 includes a lower unwinding roll 411 and a driven roll 412. An orientation of the lower carrier film F1 unwound from the unwinding roll 411 is changed to a horizontal state at a location of the driven roll 412. A placement stage 413 is provided at the location, where the lower carrier film F1 is changed to the horizontal state, to place the substrate A1 and the laminating film A2, which are the members to be molded and which are sent in a superimposed state from the previous process. Further, a carrier film unwinding apparatus 5 of the conveyance apparatus 10 includes an upper unwinding roll 414 and a driven roll 415, and the upper carrier film F2 unwound from the unwinding roll 414 is superimposed over a laminated molded article A3, which is formed of the substrate A1 and the laminating film A2, at a location of the driven roll 415. The substrate A1 and the laminating film A2 are transferred by being sandwiched between these carrier films F1 and F2, and laminate molding is performed in the vacuum laminating apparatus 2 or the press apparatus 3 through the carrier films F1 and F2, whereby the laminating film A2 is prevented from melting and adhering to the apparatus parts, and, in particular, the press apparatus 3 also has an advantage in that a certain buffer action is imparted when the intermediate laminate A4 is pressurized. Further, depending on the type of a laminated molded product A5, the laminated molded product A5 is peeled off from the carrier films F1 and F2 after a temperature of the laminated molded product A5 removed from the press apparatus 3 is lowered, whereby peeling or releasing can be performed in a good condition.

The vacuum laminating apparatus 2 disposed in the subsequent stage of the carrier film unwinding apparatus 4 of the conveyance apparatus 10 pressurizes the laminated molded article A3 formed of the substrate A1 and the laminating film A2 by a pressurizing body such as a diaphragm 211 within a chamber C in a vacuum state (depressurized state), and laminates and molds the intermediate laminate A4, which is a primary molded product. The vacuum laminating apparatus 2 is provided in such a way that a lower platen 213 can be raised and lowered by a lifting mechanism 214 relative to an upper platen 212 which is fixedly provided, and the chamber C can be formed therein when the lower platen 213 rises and comes into contact with the upper platen 212. The chamber C is connected to a vacuum pump (not shown) and configured to be depressurized. Further, a heat plate 215 is attached to a lower surface at a center of the upper platen 212, and an elastic body 216 such as a heat-resistant rubber film (not shown) is attached to a surface of the heat plate 215. On the other hand, a heat plate 217 is attached to an upper surface at a center of the lower platen 213. Further, the diaphragm 211, which serves as a pressurizing body and is made of a heat-resistant rubber film, is attached to a periphery of the heat plate 217 of the lower platen 213 so as to cover an upper surface of the heat plate 217. Then, pressurized air is sent to a rear side of the diaphragm 211 by a compressor (not shown), whereby the diaphragm 211 expands in the chamber C and pressurizes the substrate A1 and the laminating film A2 between the diaphragm 211 and the heat plate 217. Note that the diaphragm 211 of the vacuum laminating apparatus 2 may be attached to the upper platen. Further, the pressurizing body of the vacuum laminating apparatus may be one that pressurizes the substrate A1 and the laminating film A2 between roll bodies having an elastic body attached to their surfaces, or between the roll body and a pressurizing plate. The vacuum laminating apparatus may use a press apparatus in which elastic sheets such as rubber are attached to surfaces of upper and lower heat plates and the elastic sheets serve as pressurizing surfaces.

The press apparatus 3 disposed in the series direction in the subsequent stage of the vacuum laminating apparatus 2 further pressurizes the intermediate laminate A4 which has been pressure-molded by the vacuum laminating apparatus 2, thereby performing pressure molding to obtain an even flatter laminated molded product A5, the intermediate laminate A4 including the substrate A1, which is the member to be laminated having an uneven portion, and the laminating film A2 and being in a state in which there is an uneven portion on the side of the laminating film A2. The press apparatus 3 includes a substantially rectangular base platen 311 provided on a lower side, and tie bars 313 provided upright between vicinities of four corners of an upper platen 312, which is a substantially rectangular fixed platen located above the base platen 31. The press apparatus 3 is configured in which a lower platen 314, which is a substantially rectangular movable platen, can be raised and lowered between the base platen 311 and the upper platen 312. Further, the base platen 311 is provided with a pressurizing cylinder 315, which is pressurizing means and is actuated by hydraulic pressure, and a ram 316 of the pressurizing cylinder 315 is fixed to a back surface of the lower platen 314. Note that the pressurizing means of the press apparatus 3 according to the first embodiment may be of another type, such as one that uses an electric motor to rotate a ball screw to directly move the lower platen or the like, or one that uses an electric motor to move the lower platen or the like via a toggle apparatus. Further, the press apparatus 3 may be one in which the upper platen is lowered relative to the lower platen. Furthermore, the press apparatus 3 according to the first embodiment does not include a chamber capable of being in a vacuum state, but it may include a chamber capable of being in a vacuum state and perform pressurizing in the vacuum chamber.

Pressurizing blocks 317 and 318 are attached to opposite surfaces of the upper platen 312 and the lower platen 314 of the press apparatus 3, respectively. Next, the pressurizing block 318 on the lower platen 314 will be described in detail with reference to FIG. 2. Note that a buffer member 321 made of a resin film, a stainless steel metal plate 322 which is a thin metal plate, and a titanium nitride coating layer 323 are depicted in FIG. 2 with their thickness (vertical direction in FIG. 2) in a length direction (a horizontal direction in FIG. 2) thicker than an actual thickness. A heat insulating material 319 is disposed between the lower platen 314 and the pressurizing block 318 of the press apparatus 3, and a plurality of cartridge heaters 320 serving as heating means are disposed in parallel inside the pressurizing block 318. Note that the pressurizing block 318 or the like serving also as a heat plate may include a polishing plate or a plate-shaped heater as in Patent Literature 1, and is not limited to one shown in FIG. 2.

The buffer member 321 made of engineering plastic such as a polyimide film or a resin film of a thermosetting resin is superimposed on a smooth surface 318a of the pressurizing block 318. The resin film used in the present invention is an engineering plastic film or a thermosetting resin film, and is preferably an industrial functional film. Specifically, films made of engineering plastics (including super engineering plastics) such as polyimide, or thermosetting resin films made of fluorine resin are preferred. It is particularly preferable that these resin films have Rockwell R scale hardness ((ISO 2039-2) of 15 to 140 and a heat-resistant temperature of 150° C. or higher. The thickness of these resin films as the buffer member 321 is 0.005 mm to 3.00 mm, and more preferably 0.05 mm to 1.00 mm. In addition, the material of the buffer member may be elastomer, fiber, paper, or a composite of these in addition to the resin.

The metal plate 322 made of stainless steel or the like is superimposed on the surface of the buffer member 321. In the first embodiment, the surface 318a of the pressurizing block 318, the buffer member 321, and the metal plate 322 made of stainless steel have the same shape in plan view. A length of one side of the metal plate 322 and the like in plan view is 250 mm to 1,000 mm as an example, but is not limited thereto. Further, the shape of the metal plate 322 and the like may be rectangular or square, and may have various chamfered corners, uneven portions for mounting, and the like. When the material of the metal plate 322 is stainless steel, it is particularly preferable to use high-hardness martensitic stainless steel (for example, SUS440C). Alternatively, it is particularly preferable that the high-hardness stainless steel have hardness HRC of 54 or more or an elastic modulus (×10³ kg/mm²) of 20.0 or more. Alternatively, the metal forming the metal plate 322 may be stainless steel, nickel, iron, copper, zinc, aluminum, or an alloy of these metals. The thickness of the metal plate 322 is 0.05 mm to 5.0 mm, and more preferably 0.3 mm to 3.0 mm.

In the present invention, the coating layer 323 formed of at least one of titanium or a titanium alloy, nickel or a nickel alloy, a metal nitride, and DLC is formed on a surface 322a of the metal plate 322 made of stainless steel or the like. In the present embodiment, more specifically, the coating layer 323 is formed of titanium nitride (Tin) which is a type of metal nitride. The coating layer 323 is formed of the titanium nitride by an ion plating method which is a type of PVD method, and the thickness of the coating film of the coating layer 323 formed of the titanium nitride 0.1 μm to 100 μm. The thickness of the coating layer formed of the metal nitride such as titanium nitride is more preferably 0.3 μm to 2.0 μm. A pressurizing surface 323a of a surface of the coating layer 323 formed of the metal nitride such as titanium nitride by the ion plating method is polished using a polishing buff or the like as necessary, and is finished to be surface roughness as described below.

The roughness of the pressurizing surface 323a of the surface of the titanium nitride coating layer 323 formed on the surface 322a of the metal plate 322 is not limited thereto, arithmetic mean roughness Ra (JIS B0601: 2013) is preferably 0.07 μm or less, and particularly, the arithmetic mean roughness Ra is preferably 0.04 μm or less. Further, the surface roughness of the titanium nitride coating film is preferably 0.06 μm or less in maximum height roughness Rz (JIS B0601: 2013), and particularly preferably 0.35 μm or less in maximum height roughness Rz. For both the arithmetic mean roughness Ra and the maximum height roughness Rz, it is more preferable to have smaller lower limit values, but a surface treatment method is selected taking into account a relationship with costs.

The type of the metal nitride coating layer may be a coating layer obtained by nitriding of titanium or a titanium alloy such as TiC, TiCN, or TiAlN other than TiN. The coating film of the metal nitride other than titanium may be a coating layer obtained by nitriding such as CrN, molybdenum nitride, or tungsten nitride. Furthermore, an example of the material suitable for the coating layer may include DLC which is a diamond carbide coating layer. Such a coating film is also preferably 0.3 μm to 100 μm in thickness, and preferably 0.1 μm or less in surface roughness Ra. Note that as the method of forming the coating film and the like, the most suitable coating film forming method, such as the ion plating method, vacuum deposition or sputtering by PVD method, CVD method, or the like, is selected depending on the type of the coating layer.

The coating layer may be a coating layer formed of titanium or a titanium alloy, or nickel or a nickel alloy. These metals form the coating layer on the surfaces of the stainless steel metal plates 322 and 325 by plating or spraying or the like. Furthermore, the coating layer may be a mixture of coating layers formed of titanium or a titanium alloy, nickel or a nickel alloy, metal nitride, or DLC, or the coating layer may be formed as a plurality of coating layers on the metal plates 322 and 325. As an example, a surface of an intermediate layer such as a titanium nitride layer may be coated with DLC, or the coating layer of metal nitride such as titanium nitride may be coated on the surface of the intermediate layer formed of the titanium alloy or the nickel alloy or the like, with the combination being appropriately selected.

The buffer member 321 and the metal plate 322 made of stainless steel are provided with bolt holes (not shown) at a plurality of locations (for example, four locations, six locations, or eight locations) around the periphery other than the pressurizing surface. Then, bolts (not shown) are inserted through the holes from a front side of the metal plate 322 into bolt holes of the pressurizing block 318, and the buffer member 321 and the metal plate 322 made of stainless steel are fixed to the pressurizing block 318. Note that in order to allow for thermal expansion of the metal plate 322 and the like made of stainless steel, adjustment portions formed by holes or long holes larger than the cross-sectional area of the bolts may be provided at portions into which the bolts are inserted. Further, the buffer member 321 and the metal plate 322 made of stainless steel may be attached to the pressurizing block 318 by holders other than the bolts or by adhesion with an adhesive. With the above-described structure, the pressurizing block 318 of the press apparatus 3 is provided with the metal plate 322 through the buffer member 321, which is a buffer member.

In the press apparatus 3 of the first embodiment, the upper platen 312 also includes a pressurizing block 317, a buffer member 324, and a metal plate 325 having the same side size and area as the lower platen 314. The surface of the metal plate 325 is provided with the stainless steel metal plate 325 coated with a coating layer 326 of titanium nitride. However, the metal plate 325 of the pressurizing block 317 on the upper platen 312 side may be different in plate thickness, type of the coating layer on the surface, or surface roughness, from the metal plate 322 of the pressurizing block 318 on the lower platen 314 side.

A carrier film unwinding apparatus 5 of the conveyance apparatus 10 serving as both a transfer apparatus and a tension apparatus for the laminated molded product A5 is provided in the subsequent stage of the press apparatus 3. The carrier film unwinding apparatus 5 includes a lower winding roll 511 and a driven roll 512, and the lower carrier film F1 is wound by the winding roll 511. The carrier film unwinding apparatus 5 also includes an upper winding roll 513 and a driven roll 514, the upper carrier film F2 is peeled off from the laminated molded product A5 at the driven roll 514, and the upper carrier film F2 is wound onto the upper winding roll 513. A takeout stage 515 for the laminated molded product A5 is provided at a portion where only the lower carrier film F1 is fed in a horizontal state. Note that a transfer apparatus may be provided, as a transfer apparatus for the carrier films F1 and F2, to grip both sides of the carrier films F1 and F2 and pull them toward a subsequent stage. Further, the conveyance apparatus 10, which conveys the laminated molded article A3 of the lamination molding system 1 to the vacuum laminating apparatus 2 and conveys the intermediate laminate A4 laminated and molded by the vacuum laminating apparatus 2 to the press apparatus 3, is not limited to the above, and may also be a multi-axis robot, for example.

Next, a description will be given with respect to a lamination molding method for the substrate A1 which is a member to be laminated and the laminating film A2, using the lamination molding system 1 including the press apparatus 3 of the first embodiment. In the lamination molding system 1 during continuous molding, pressure molding is performed in batch mode at the same time by sequence control in the diaphragm-type vacuum laminating apparatus 2 and the press apparatus 3 which is a flattening press apparatus. However, the description will be given herein along a molding sequence of the substrate A1 which is a member to be laminated and the laminating film A2 for one batch. The upper and lower carrier films F1 and F2, which are provided to be unwound from the carrier film unwinding apparatus 4 of the conveyance apparatus 10 and wound up on the carrier film unwinding apparatus 5, are often made of polyethylene terephthalate (PET) and have a thickness of 0.01 mm to 0.50 mm, but are not limited thereto. The carrier films F1 and F2 may also be made of other materials, for example, polyethylene, polypropylene, and polyimide.

The substrate A1 placed on the placement stage 413 of the conveyance apparatus 10 is a build-up circuit substrate including an uneven portion A1a formed by a protrusion A1b with a copper foil bonded to the surface of the substrate and a recess A1c without a copper foil. A thickness of the copper foil (height relative to the substrate) is in a range of several μm to several tens of μm, but is not limited thereto, and is 0.1 mm or less in most cases. The laminating film A2 is superimposed on the top and bottom of the substrate A1 to form a laminated molded article A3 for build-up molding. Note that although one laminated molded article A3 is shown in FIG. 1, a plurality of laminated molded articles A3 may be laminated and molded at the same time.

The laminating film A2 in the first embodiment is an insulating film, and is used in a state where PET films laminated on both sides thereof are peeled off from the original preservation state. The resin material of the laminating film A2 is a thermosetting resin such as epoxy or a resin having a thermosetting resin as a main component. In addition to the thermosetting resin, various materials and additives are contained for the purpose of adjusting roughness, imparting flame retardancy, imparting low expansion properties, imparting fluidity, imparting film-forming properties, making low dielectric loss tangent (imparting insulating properties), and reducing moisture content. In particular, in recent years, there has been an increase in types in which the content of inorganic materials is increased in order to impart adjust roughness, impart low expansion properties, make low dielectric loss tangent, reduce moisture content, and the like. The types of inorganic materials may include SiO₂ and the like, but are not limited thereto.

In the first embodiment, a laminating film A2 having a content (volume %) of SiO₂, which is an inorganic material, of 20% or more is preferably used. In the present invention, the laminating film A2 having the content (volume %) of SiO₂, which is an inorganic material, of 20% or more is defined as a laminating film having a high content of inorganic material. An example of an interlayer insulating film “Ajinomoto Build-up Film (ABF)” (registered trademark), manufactured by Ajinomoto Fine-Techno Co., Inc. include, but is not limited to, GX13 (Young's modulus (GPa) 4.0), GX92 (Young's modulus (GPa) 5.0), GX-T31 (Young's modulus (GPa) 7.5), Next GX (Young's modulus (GPa) 7.5), GZ41 (Young's modulus (GPa) 9.0), or a film with Young's modulus (GPa) 9.0 or more as a laminating film with a high content of inorganic material to be used.

Laminating films of other companies' products that contain similar materials with a higher content of inorganic material are also considered. As described above, these laminating films contain 20 volume % or more or 40 weight % or more of inorganic material for the purpose of improving adhesion to the object to be laminated by reducing the roughness of the film surface, preventing peeling from the substrate by reducing the thermal expansion coefficient, improving the insulating properties (reducing dielectric loss), and reducing the moisture content. In particular, for substrates for 5G, which is the fifth generation communication system, even greater precision is required, so the laminating film A2 (interlayer insulating film) with the content of inorganic material of 25 volume % or more is particularly preferably used. The thickness of the laminating film A2 is not limited, in the interlayer insulating films made by Ajinomoto Fine-Techno Co., Inc. and the like, the films having a thickness of 0.01 mm to 0.1 mm are commercially available and widely used.

Furthermore, the laminating film A2 may be one having a copper foil layer laminated thereon, and such a film is also used in the press apparatus 3 of the lamination molding system 1 of the present invention.

Then, the laminated molded article A3 placed on the placement stage 413 is fed together with the upper and lower carrier films F1 and F2 as the winding rolls 511 and 513 are rotated and driven, and is fed and positioned inside the chamber C of the vacuum laminating apparatus 2 being an open state. Next, the chamber C of the vacuum laminating apparatus 2 is closed, and the inside of the chamber C is evacuated by a vacuum pump (not shown). Pressurized air is then sent to cause the diaphragm 211 to expand into the chamber C, and the laminated molded article A3 formed by the substrate A1 and the laminating film A2 is pressurized between the diaphragm 211 and the elastic body 216 of the heat plate 215 on the upper platen 212 side. At this time, the pressure applied by the diaphragm 211 is, for example, 1.0 MPa or less, and the substrate A1 and the laminating film A2 are bonded together in such a manner that the laminating film A2 is embedded in the recess A1c of the substrate A1, and the intermediate laminate A4, which is the primary molded product, is laminated and molded. However, the surface of the laminating film A2 of the intermediate laminate A4 laminated and molded by the vacuum laminating apparatus remains in an uneven state following the shape of the uneven portion A1a of the substrate A1. Furthermore, when the laminating film A2 used in this case has a high content of inorganic material, the fluidity of the molten resin is low, and thus unevenness is more likely to remain.

The intermediate laminate A4, which is formed by the substrate A1 with the uneven portion A1a and the laminating film A2 attached to each other, is laminated and molded in the vacuum laminating apparatus 2, and then the chamber C is opened. Then, the intermediate laminate A4 is conveyed between the upper platen 312 and the lower platen 314 of the press apparatus 3 by feeding of the next carrier films F1 and F2 by the carrier film unwinding apparatus 5 of the conveyance apparatus 10, and is stopped at a predetermined pressurizing position. Next, the pressurizing cylinder 315 of the press apparatus 3 is actuated to raise the lower platen 314 and the pressurizing block 318. The pressurizing block 318 is attached with the stainless steel metal plate 322, which is elastically deformable via the buffer member 321 having a buffer action and has the titanium nitride coating layer 323 formed on its surface, as described above, but the pressurizing surface 323a on the surface of the titanium nitride coating layer 323 of the stainless steel metal plate 322 comes into contact with the lower carrier film F1, and then the intermediate laminate A4 is further pushed up via the lower carrier film F1. Then, the intermediate laminate A4 comes into contact with the pressurizing surface 326a on the surface of the titanium nitride coating layer 326 on the surface of the stainless steel metal plate 325 of the upper platen 312 via the upper carrier film F2, and the intermediate laminate A4 is then pressurized between the upper and lower pressurizing surfaces 323a and 326a via the carrier films F1 and F2.

The temperature of the pressurizing blocks 317 and 318 (heat plates) of the press apparatus 3 at this time varies depending on the materials of the substrate A1 and the laminating film A2, and thus is controlled to 30° C. to 200° C., more preferably 80° C. to 140° C., but is not limited thereto. When the temperature at this time is too high, the resin material constituting the laminating film is low in viscosity and is too high in fluidity when being melted, whereby the resin material constituting the laminating film flows out from an end of the intermediate laminate A4, and the laminated molded product having a desired plate thickness and a desired insulating layer thickness is not obtained. Furthermore, when the temperature of the pressurizing blocks 317 and 318 is too high during the pressurizing, problems arise also in that the resin material deteriorates and the molding cycle time including cooling in the subsequent stage takes longer. On the other hand, when the temperature of the pressurizing blocks 317 and 318 is too low during the pressurizing, problems arise in that the viscosity of the resin material will be too high to obtain the desired fluidity, the laminating film A2 cannot be sufficiently embedded in the substrate A1, and the surface of the laminated molded product A5 does not have sufficient flatness.

In addition, the pressure (surface pressure) applied to the intermediate laminate A4 also varies depending on the materials of the substrate A1 and the laminating film A2, and thus is controlled to 0.1 MPa to 3.0 MPa, more preferably 0.5 MPa to 2.5 MPa, but is not limited thereto. When the applied pressure is too strong at this time, the molten resin material constituting the laminating film A2 flows out from the end of the intermediate laminate A4, and thus pressure molding cannot be performed satisfactorily, as with the temperature conditions. When the applied pressure is too low, the laminating film A2 cannot be sufficiently embedded in the substrate A1, and the surface of the laminated molded product A5 does not have sufficient flatness.

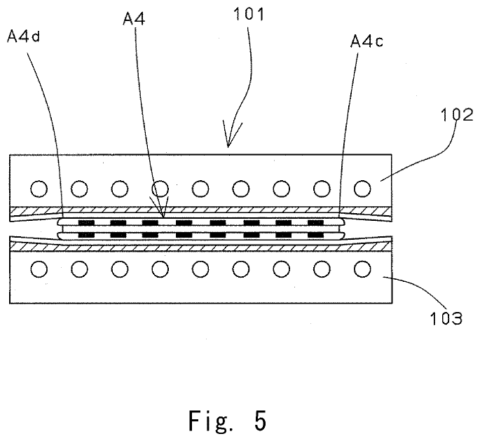

In the first embodiment, the stainless steel metal plates 322 and 325, which are metal plates formed with the coating layers 323 and 326 of titanium nitride or the like on their surfaces, are used, the intermediate laminate A4 is pressurized through the carrier films F1 and F2, whereby the smoothness of the intermediate laminate A4 can be improved. In addition, it is possible to improve the uniformity of the surface pressure distribution during pressurizing the intermediate laminate A4 by using the stainless steel metal plates 322 and 325 formed with the titanium nitride coating layers 323 and 326 and the buffer members 321 and 324 of the resin films made of polyimide or fluorine resin. Alternatively, by a combination of the coating layers 323 and 326 with the buffer members 321 and 324 made of the resin film, it is possible to prevent the resin material of the molten laminating film A2 from flowing outward, which is previously caused by stress concentration during pressurizing near the ends A4c and A4d of the intermediate laminate A4 when the intermediate laminate A4 is pressurized between pressurizing blocks 102 and 103 of a press apparatus 101 as shown in FIG. 5 in the related art.

Then, when a predetermined pressurizing time has elapsed in the press apparatus 3, the pressurizing cylinder 315 of the press apparatus 3 is actuated, and the lower platen 314 and the pressurizing block 318 are lowered. Thus, the lower carrier film F1 is released from the pressurizing surface 323a of the titanium nitride coating layer 323 formed on the surface 322a of the metal plate 322 attached to the pressurizing block 318 on the lower platen 314 side. Further, the upper carrier film F2 is released from the pressurizing surface 326a of the titanium nitride coating layer 326 formed on the surface of the metal plate 325 attached to the upper platen 312 side. In the present invention, however, since the titanium nitride coating layers 323 and 326 are formed on the surfaces of the metal plates 322 and 325, respectively, the release from the carrier films F1 and F2 can be performed more easily compared to the related art. Therefore, it is possible to minimize the phenomenon that at least one of the carrier films F1 and F2 is released while being still attached to the metal plate and the laminated molded product A5 press-molded between the carrier films F1 and F2 is unintentionally released from the carrier films F1 and F2 in the press apparatus 3.

Then, the laminated molded product A5, which has been completely laminated and molded in the press apparatus 3, is fed to the takeout stage 515 for the laminated molded product A5 when the carrier film unwinding apparatus 5 of the conveyance apparatus 10 is actuated in the next molding cycle. By this time, the upper carrier film F2 is satisfactorily released from the laminated molded product A5 at the driven roll 514. Then, the laminated molded product A5 is taken out from the takeout stage 515 by a robot or the like. When the laminated molded product A5 is a substrate for a build-up substrate, the smoothness of the surface is particularly important, and therefore the present invention is effective. Note that in the case of the substrate for a build-up substrate, although the surface of the laminated molded product A5 may be very finely roughened with chemicals or the like in order to attach copper foil or the like in the next process, since the surface smoothness of the present invention requires smoothness on a larger scale than that, it is important to ensure the smoothness of the laminated molded product A5 for a build-up substrate using the press apparatus 3 in any case.

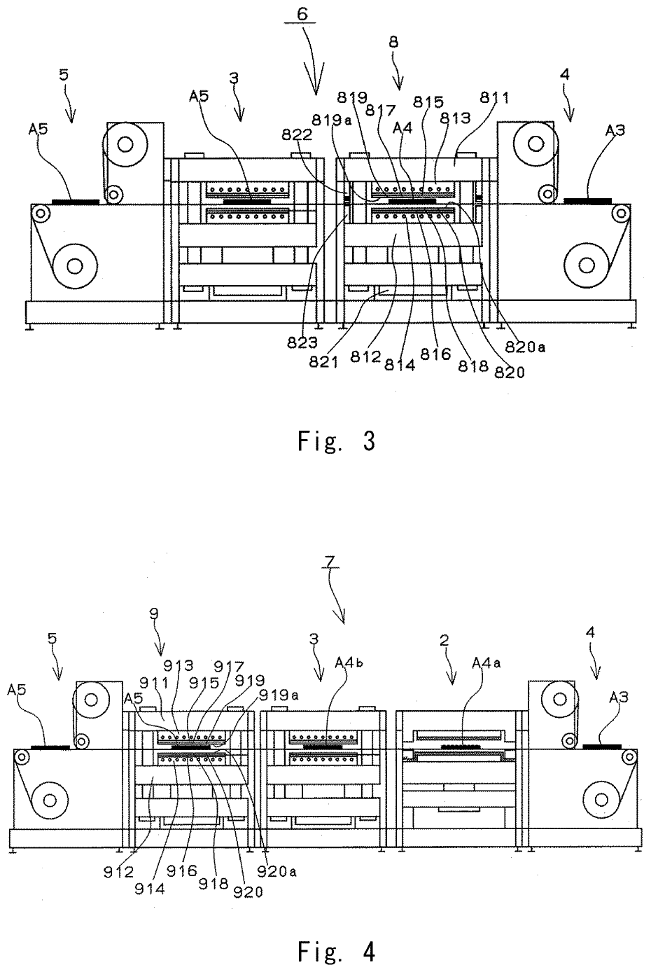

Next, a description will be mainly given with respect to differences between a lamination molding system 6 of a second embodiment shown in FIG. 3 and the lamination molding system 1 of the first embodiment with reference numerals. A press apparatus 8 of the lamination molding system 6 of the second embodiment does not use a diaphragm, and a pressurizing mechanism such as a pressurizing cylinder 821 has almost the same structure as the press apparatus 3 of the first embodiment. In the press apparatus 8, pressurizing blocks 813 and 814, which are attached to an upper platen 811 and a lower platen 812, respectively, include buffer members 815 and 816 being buffer members and made of a resin film such as polyimide and metal plates 817 and 818 being thin metal plates and made of stainless steel, respectively, and coating layers 819 and 820 of titanium nitride, which are the same as those in the first embodiment, are formed on surfaces of the stainless steel metal plates 817 and 818, respectively. Then, surfaces of the coating layers 819 and 820 serve as pressurizing surfaces 819a and 820a, respectively. Furthermore, similarly, the lower platen 812 is raised by the pressurizing cylinder 821 and pressure molding is performed between the pressurizing surfaces 819a and 820a.

The press apparatus 8 of the lamination molding system 6 according to the second embodiment is different from the press apparatus 3 of the first lamination molding system 1 in that the press apparatus 8 is configured in which at least one of the upper platen 811 and the lower platen 812 is formed with side walls 822 and 823 which are chamber forming members and a chamber C is formed when a relative distance between the upper platen 811 and the lower platen 812 becomes closer as the lower platen 812 or the like is raised. The press apparatus 8 includes a vacuum pump (not shown) that evacuates the inside of the chamber C. Therefore, the press apparatus 8 is a vacuum laminating apparatus.

In addition, the press apparatus 3, which is the same as in the first embodiment, is provided in the subsequent stage of the press apparatus 8 to be used for secondary molding. The press apparatus 8 includes the buffer members 815 and 816 as buffer members made of a resin film such as polyimide and the stainless steel metal plates 817 and 818 which are thin metal plates. The stainless steel metal plates 817 and 818 of the press apparatus 8, the stainless steel metal plates 817 and 818 of the press apparatus 3, and the stainless steel metal plates 322 and 325 of the press apparatus 3 may be made of the same material or different materials. Furthermore, the coating layers of titanium nitride or the like on the metal plates 817 and 818 and the coating layers 323 and 326 of titanium nitride or the like on the metal plates 322 and 325 may be made of the same material or different materials, and may have the same or different surface roughness (arithmetic mean roughness Ra or maximum height roughness Rz. Note that the coating layers 323 and 326 of titanium nitride or the like on the metal plates 322 and 325 of the press apparatus 3 in the subsequent stage may have smaller surface roughness.

Next, a description will be mainly given with respect to differences between a lamination molding system 7 of a third embodiment shown in FIG. 4 and the lamination molding system 1 of the first embodiment with reference numerals. The lamination molding system 7 of the third embodiment is configured such that another similar press apparatus 9 is provided in the subsequent stage of the press apparatus 3 of the lamination molding system 1 of the first embodiment. In other words, the two press apparatuses 3 and 9 of the lamination molding system 7 are provided in the series direction in the subsequent stage of the vacuum laminating apparatus 2. Then, the intermediate laminate A4 formed by the substrate A1 having the uneven portion and the laminating film A2 which are conveyed from the vacuum laminating apparatus 2 by the carrier films F1 and F2 are successively pressure-molded by the two press apparatuses 3 and 9.

The press apparatus 9 has almost the same structure as the press apparatus 3, pressurizing blocks 913 and 914, being attached to an upper platen 911 and a lower platen 912, respectively, include buffer members 915 and 916 made of a resin film such as polyimide and metal plates 917 and 918 made of stainless steel, respectively, coating layers 919 and 920 made of titanium nitride or the like are formed on surfaces of the stainless steel metal plate 918, and such surfaces serve as pressurizing surfaces 919a and 920a.

Note that the buffer members 915 and 916 made of the resin film and the stainless steel metal plates 917 and 918 in the press apparatus 9, and the buffer members 321 and 324 made of the resin film and the stainless steel metal plates 322 and 325 in the press apparatus 3 may have the same thickness, or one of them may be thicker. In addition, the coating layers 919 and 920 of titanium nitride or the like formed on the metal plates 917 and 918 and the coating layers 323 and 326 of titanium nitride or the like formed on the metal plates 322 and 325 may have the same material or thickness, or one of them may be thicker.

In a lamination molding method using the lamination molding system 6 of the third embodiment, intermediate laminates A4a and A4b, which have been laminated and molded, are fed in this order to the vacuum laminating apparatus 2, the press apparatus 3, and the press apparatus 9. In a case of two laminating apparatuses as in the first embodiment, the press apparatus 3 often required a longer pressurizing time compared to the vacuum laminating apparatus 2, and a total molding time was often defined by the press apparatus 3. However, according to the lamination molding system 7 of the third embodiment, the molding time can be distributed by two times of pressure molding with the press apparatus 3 and the press apparatus 9, and molding can also be performed using the other press apparatus 3 and press apparatus 9 at the molding time required for the vacuum laminating apparatus 2 in most cases.

Furthermore, since the pressure molding can be performed twice using the press apparatus 3 and press apparatus 9, even when the laminating film A2 contains a large amount of inorganic material and has poor fluidity during melting, it can be laminated and molded satisfactorily. In addition, the temperature and applied pressure (surface pressure) of the pressurizing blocks of the press apparatus 3 and the press apparatus 9 may be the same or different. As an example, although not limited to the example, the temperature of the pressurizing block in the press apparatus 3 may be set higher than that in the press apparatus 9 to improve the fluidity of the molten resin material of the laminating film A2, and the press apparatus 9 may apply a higher pressure than the press apparatus 3 to increase the smoothness of the surface of the laminated molded product A5. In the third embodiment, a further apparatus such as a cooling press apparatus may also be provided in the subsequent stage of the press apparatus 9.

Note that as a modified example of the third embodiment, a press apparatus of which pressurizing surface is made of an elastic plate of rubber or the like may be used instead of the press apparatus 3 installed next to the vacuum laminating apparatus 2. In this case, the press apparatus of the present invention is used only for third lamination molding.

It is also assumed that the press apparatuses 3, 8, and 9 of the present invention may be shipped in a state where the resin film serving as a buffer member or the metal plate is not attached, and that a metal having a coating layer of titanium nitride or the like of the present invention formed thereon is attached later, and such configurations are also included in the present invention.

Although not enumerated herein, the present invention is not limited to the first to third embodiments described above, and it goes without saying that the present invention can also be applied to modifications made by those skilled in the art based on the spirit of the present invention, or to combinations of the descriptions of the first to third embodiments. The laminated molded product laminated and molded by the lamination molding system 1, 6, or 7 is particularly suitable for the laminated molded product for which surface roughness is important, and may be, but is not limited to, other circuit substrates, semiconductor wafers, and the like other than the build-up substrate.

### REFERENCE SIGNS LIST

1, 6, 7 LAMINATION MOLDING SYSTEM
2 VACUUM LAMINATING APPARATUS
3, 8, 9 PRESS APPARATUS
212, 312, 811, 911 UPPER PLATEN
213, 314, 812, 912 LOWER PLATEN
317, 318, 813, 814, 913, 914 PRESSURIZING BLOCK
321, 324, 815, 816, 915, 916 BUFFER MEMBER
322, 325, 817, 818, 917, 918 METAL PLATE
323, 326, 819, 820, 919, 920 COATING LAYER
323a, 326a, 821a, 822a, 919a, 920a PRESSURIZING SURFACE

1. A surface member provided on a surface of a pressurizing block used in a lamination molding system for molding a laminated molded product in which a laminating film is laminated on a substrate, the surface of the pressurizing block facing the laminated molded product, the surface member comprising:
a first member; and
a second member having a chemical composition different from a chemical composition of the first member,
wherein the first member is detachably fixed to the pressurizing block.

2. The surface member according to claim 1, the surface member has a through hole at least at one location.

3. The surface member according to claim 2, wherein the through hole has a circular shape.

4. The surface member according to claim 2, wherein the through hole has a cross-sectional area in an inner diameter direction larger than a cross-sectional area in an inner diameter direction of a bolt fastening hole that is provided in the pressurizing block and is used to fix the surface member to the pressurizing block.

5. The surface member according to claim 1, wherein
the first member is provided on a surface of a buffer member provided between the pressurizing block and the surface member, the surface facing the laminated molded product, and
the first member has at least one of a protrusion and a recess on a surface that contacts the buffer member.

6. The surface member according to claim 1, wherein the surface member is formed of a metal plate and a coating layer coated on a surface of the metal plate.

7. The surface member according to claim 6, wherein the metal plate is formed of an alloy containing at least any one of chemical components Ni, Fe, Cu, Zn, and Al.

8. The surface member according to claim 7, wherein the metal plate is stainless steel.

9. The surface member according to claim 6, wherein the metal plate has a thickness of 0.05 mm to 5.0 mm.

10. The surface member according to claim 6, wherein the coating layer is formed of a material containing at least any one of chemical components Ti, Ni, Al, Cr, Mo, W, N, and C.

11. The surface member according to claim 10, wherein the coating layer is formed of a titanium-containing nitrogen compound.

12. The surface member according to claim 6, wherein the coating layer has a thickness of 0.1 μm to 100 μm.

13. The surface member according to claim 6, wherein the coating layer has a surface roughness Ra of 0.1 μm or less.

14. The surface member according to claim 6, wherein the coating layer has a surface roughness Rz of 0.06 μm or less.

15. A method of producing a laminated molded product using a lamination molding system for molding a laminated molded product in which a laminating film is laminated on a substrate, the method comprising:
detachably fixing a surface member including a first member and a second member having a chemical composition different from a chemical composition of the first member to a pressurizing block of the lamination molding system; and
using a pressure generated as the pressurizing block is raised and lowered to increase flatness of a surface of the laminated molded product.

16. A press apparatus comprising:
a pressurizing mechanism that raises and lowers a pressurizing block; and
a surface member including a first member and a second member having a chemical composition different from a chemical composition of the first member, the first member being detachably fixed to the pressurizing block.
